(19) United States
(12) Patent Application Publication
(10) Pub. No.: US 2006/0276235 A1
(43) Pub. Date: Dec. 7, 2006

(54) Hands-free device for a mobile telephone

(76) Inventor: Roman Piekarz, Mielec (PL)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/382,723

(22) Filed: May 11, 2006

(30) Foreign Application Priority Data
May 12, 2005 (DE) 10 2005 022 784.8

(51) Int. Cl. H04M 1/00

(52) U.S. Cl. 455/569.1

(57) ABSTRACT

A hands-free device for a mobile telephone which has a telephone transceiving unit for a mobile radio network and in addition a communication device for the wireless transmission of audio and data signals, with a housing (1) in which a communication device forming a wireless communication connection to the communication device of the mobile telephone and electronics for picking up, converting and forwarding and for reproducing audio signals is located, provides for the operation with a mobile telephone without permanent installations or at least without voluminous permanent installations in a motor vehicle due to the fact that the housing (1) is provided with a display (6) which can be activated for displaying data transmitted wirelessly from the mobile telephone, a cable (4, 4′) establishing the connection to a power supply is brought out of the housing (1) and an operating unit (15, 32) is provided for operating a mobile telephone via the wireless communication connection.

### FIELD OF THE INVENTION

The invention relates to a hands-free device for a mobile telephone which has a telephone transceiving unit for a mobile radio network and in addition a communication device for the wireless transmission of audio and data signals, with a housing in which a communication device forming a wireless communication connection to the communication device of the mobile telephone and electronics for picking up, converting and forwarding and for reproducing audio signals is located.

### DESCRIPTION OF THE RELATED ART

Such hands-free devices are known. They have a holder into which the mobile telephone can be inserted. The wireless communication devices are constructed in accordance with a standard, namely in accordance with the Bluetooth standard. The holder is normally connected to a control box installed in a vehicle via which audio signals transmitted from the mobile telephone are forwarded, for example to a loudspeaker. Conversely, audio signals picked up by a microphone can be transferred to the telephone and radiated by the telephone via the telephone transmitting unit. The disadvantageous factor in this known system is that there is a not inconsiderable space requirement for the permanently installed parts of the hands-free device which is not always available in motor vehicles.

### SUMMARY OF THE INVENTION

The present invention is, therefore, based on the object of constructing a hands-free device of the type initially mentioned in such a manner that no parts or only parts of small volume need to be permanently installed.

According to the invention, to achieve this object, a hands-free device of the type initially mentioned is distinguished by the fact that the housing is provided with a display which can be activated for displaying data transmitted wirelessly from the mobile telephone, a cable establishing the connection to a power supply is brought out of the housing and an operating unit is provided for operating the mobile telephone via the wireless communication connection.

The hands-free device according to the invention can thus be accommodated in a single housing which is provided with a display and thus provides for comfortable operation. The housing can be mounted unproblematically in the passenger space of a motor vehicle, preferably by means of a plug-in foot, appropriately within the field of view of the driver at a point at which no interference with the traffic perception is to be feared. The hands-free device is supplied with power via the cable brought out of the housing, in the simplest manner by insertion into a cigarette lighter contact as a result of which the cable must be run over a certain length in the passenger space.

As an alternative, the cable can be connected to a connection box which is permanently (and in a hidden manner) installed in the vehicle to which a supply voltage and any loudspeakers and/or microphones installed can be connected. The connection box needs extremely little installation space which is always available in a suitable manner. In this embodiment, the cable can be run from the housing on a short path, said cable being hidden, preferably behind the dashboard.

In a preferred embodiment of the invention, the housing is constructed of two parts and consists of a permanently mountable plug-in foot and a display part which can be connected thereto in a locking manner.

If the housing has at least one inbuilt loudspeaker but preferably at least two inbuilt loudspeakers for reproduction in stereo quality, the connection to an external loudspeaker can be omitted so that the hands-free device does not need to use loudspeakers installed in the vehicle. If, however, a connection is established to an external loudspeaker, for example via the connection box, the loudspeakers installed in the housing are switched off. The loudspeakers are suitably located in the display part of the housing constructed of two parts.

It is advantageous to use a subsequently installed hands-free device with a suitably positioned microphone. Accordingly, it is appropriate if the housing is provided with a connection socket for an external microphone. This connection socket too is preferably accommodated in the display part in the case of a housing constructed of two parts. As an alternative, a microphone can also be installed in the housing itself.

In contrast, the power supply, that is to say the cable leading away from the housing, is brought out of the plug-in foot in the case of the two-part housing.

The hands-free device according to the invention with its display can also be suitably used for supporting the driver in his route selection. Without great additional expenditure, the housing can be provided with an antenna receiving traffic radio messages and an evaluation circuit decoding the traffic radio messages, the antenna suitably being accommodated in the plug-in foot of the housing constructed of two parts.

The operating unit of the hands-free device is preferably arranged on the top of the display part. In supplementary manner or as an alternative, the operating unit can advantageously also be constructed as a wireless remote control which can be subsequently mounted at a suitable point, for example at the steering wheel, and can be constructed as an infrared or radio remote control. With such an operating unit, in particular, dialing signals can also be transmitted to the mobile telephone via the hands-free device by means of the wireless communication connection. The dialing process can thus be initiated by the driver himself, for example at the steering wheel, so that the distraction from the traffic conditions associated with a dialing process can be kept minimal.

### BRIEF DESCRIPTION OF THE DRAWINGS

In the text which follows, the invention will be explained in greater detail with reference to exemplary embodiments shown in the drawing, in which:

FIG. 1 shows a diagrammatic representation of a hands-free device according to a first embodiment of the invention, with a connecting cable for the power supply,

FIG. 2 shows two parts of the housing of the hands-free device according to FIG. 1 in separated form,

FIG. 3 shows a diagrammatic representation of a hands-free device according to a second embodiment of the invention,

FIG. 4 shows the hands-free device according to FIG. 3 with separated parts of the housing.

### DETAILED DESCRIPTION OF THE PREFERRED EMBODIMENT

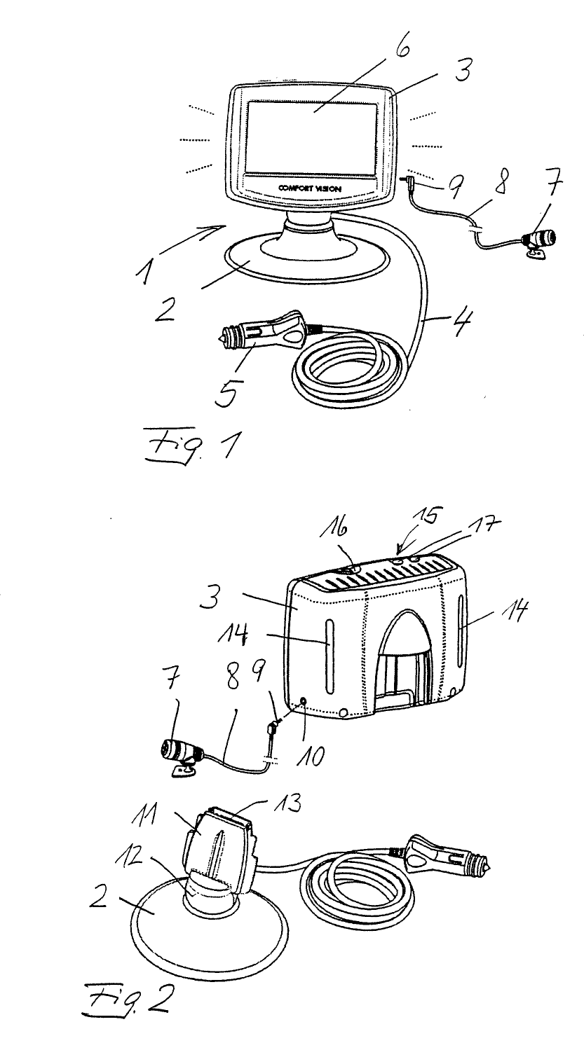

The hands-free device shown in FIGS. 1 and 2 has a housing 1 which is formed from a plug-in foot 2 and a display part 3. A cable 4 is brought out of the plug-in foot 2 of the housing 1, which cable is used as power supply cable and, therefore, has at its end a connector 5 which can be brought into contact with a cigarette lighter plug-in contact of a motor vehicle in order to thus feed the onboard voltage of the motor vehicle to the hands-free device.

The display part 3 of the housing 1 has at its front a display 6 for displaying telephone data, for example the number of a subscriber dialed or of a caller. An external microphone 7, which can be connected to the hands-free device with a connecting cable 8 and a conventional connecting plug 9 with a microphone socket 10 attached to the side of the display part 3 of the housing 1, can be connected to the display part 3.

FIG. 2 illustrates that the display part 3 can be plugged onto the plug-in foot 2. For this purpose, the plug-in foot 2 has a rectangular connector 11 which is attached to the plug-in foot 2 by means of a ball joint 12. The rectangular connector 11 is provided with plug-in contacts 13 which are accessible from the top and by means of which the electrical connection can be established to the display part 3 when the display part 3 is pushed onto the rectangular connector 11 from the top to the bottom in order to establish a locking connection between the display part 3 and the plug-in foot 2.

In the display part 3, a communication device is located which can establish and maintain a wireless communication connection according to the Bluetooth standard to a mobile telephone with a corresponding communication device. In this manner, the telephone data of the mobile telephone pass to the hands-free device and can be displayed on the display 6.

The display part 3 has at its rear/at its side walls two inbuilt loudspeakers which radiate the sound through associated exit slots 14. In FIG. 1, the sound radiation in stereo quality to both sides of the display system 3 is symbolized by dotted lines. Using the connected microphone 7, the hands-free operations of the hands-free device can thus be carried out without there being a further connection to the mobile telephone.

A telephone call is carried out via the transceiving device of the mobile telephone which only needs to maintain the Bluetooth communication connection to the hands-free device and, therefore, does not have a fixed location. For example, the mobile telephone can remain in a jacket pocket of the driver of the motor vehicle for receiving a telephone call.

To control the telephone functions, the housing 1 is provided with an operating device 15 which consists of an on/off key 16 and two keys 17 by means of which the acceptance and the terminating of telephone calls, the regulation of the loudspeakers and the “pairing” of the Bluetooth communication devices are controlled. The “pairing” is used for tuning the communication protocol in accordance with the Bluetooth standard and adjusting the two communication devices to one another for establishing the wireless communication connection.

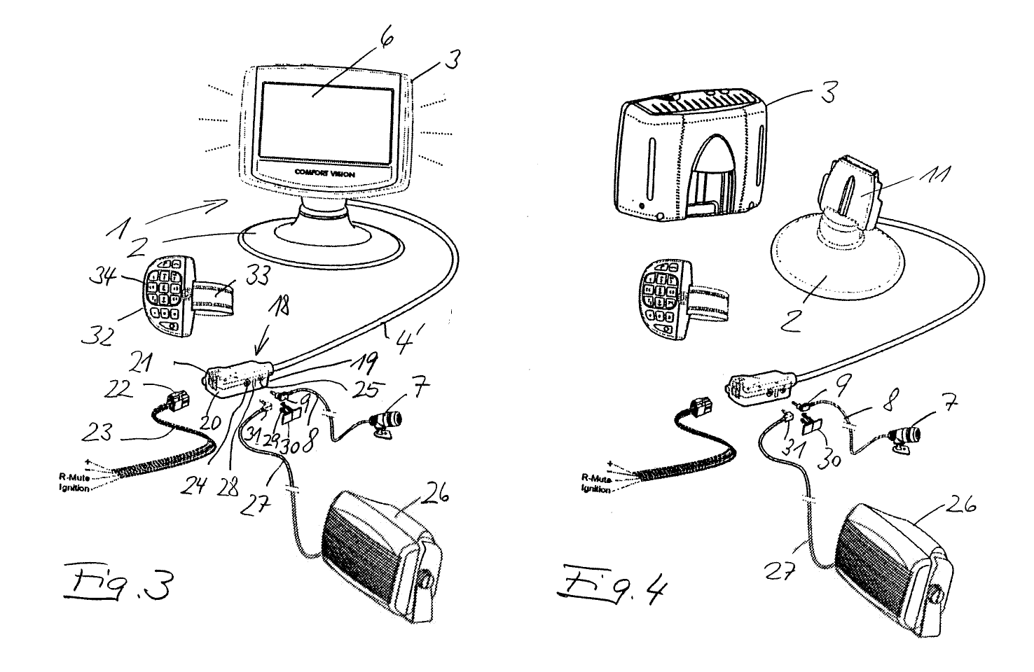

In the second exemplary embodiment of the invention, shown in FIGS. 3 and 4, the housing 1 is constructed virtually identically. Only the cable 4′, which is brought out of the plug-in foot 2, ends in a connection box 18 and is brought into a first small end side 19 of the connection box 18. The opposite end side 20 of the connection box 18 has a connector socket 21 for contacting a connector 22 of a control cable 23. The control cable 23 carries a supply voltage and control signals for muting a car radio (R-mute) from the telephone and a signal characterizing the state of the ignition (ignition) from the standard terminal 15 of the car electronics. By means of the signal of an incoming call, conveyed from the mobile telephone via the wireless communication connection to the hands-free device, the car radio located in the motor vehicle is thus muted by the hands-free device via the control cable 23 in order not to disturb the telephone call. Correspondingly, the signal characterizing the state of the ignition “ignition” is used for switching the hands-free device on and off, respectively.

In this embodiment, a loudspeaker 26 and/or the external microphone 7 can be connected by means of a loudspeaker cable 27 or the microphone cable 8 to corresponding sockets 24, 25 in a jacket wall of the cylindrical connection box 18. Between the connection sockets 24, 25, the connection box 18 has a locking recess 28 into which the locking ridges 29 of a cover 30 can be locked. The cover 30 can be used for securing the connector 31 attached to the end of the loudspeaker cable 27 and/or the connector 9 of the microphone cable 8.

In this embodiment, the display part 3 is equipped with a remote control receiver (not shown) in the form of an infrared or radio receiver so that the hands-free device can be operated via a remote control 32 which can be attached to the steering wheel of the motor vehicle by means of an adjustable attachment band 33. In particular, the remote control can have a keypad 34 in order to control a dialing process of the mobile telephone via the hands-free device and the wireless communication connection to the mobile telephone.

The hands-free device according to the invention thus provides for the hands-free operation of a mobile telephone which establishes and maintains the telephone connection via the mobile radio network with its own telephone transceiving units. It is only the audio data and certain control functions which are transmitted to the hands-free device via the wireless communication connections so that the hands-free operation can be carried out with the microphone 7 and the loudspeaker 26 or the inbuilt loudspeaker 14, respectively, and certain data such as, for example, the telephone number of the call partner are displayed on the display 6.

1. A hands-free device for a mobile telephone which has a telephone transceiving unit for a mobile radio network and in addition a communication device for the wireless transmission of audio and data signals, with a housing (1) in which a communication device forming a wireless communication connection to the communication device of the mobile telephone and electronics for picking up, converting and forwarding and for reproducing audio signals is located, wherein the housing (1) is provided with a display (6) which can be activated for displaying data transmitted wirelessly from the mobile telephone, a cable (4, 4′) establishing the connection to a power supply is brought out of the housing (1) and an operating unit (15, 32) is provided for operating the mobile telephone via the wireless communication connection.

2. The hands-free device as claimed in claim 1, wherein the housing (1) is constructed of two parts and consists of a permanently mounted plug-in foot (2) and a display part (3) which can be connected thereto in a locking manner.

3. The hands-free device as claimed in claim 1, wherein the housing (1) has at least one inbuilt loudspeaker.

4. The hands-free device as claimed in claim 2, wherein at least one loudspeaker is installed in the display part (3) of the housing (1).

5. The hands-free device as claimed in claim 1, wherein the housing (1) is provided with a connection socket (10) for an external microphone (7).

6. The hands-free device as claimed in claim 2, wherein the connection socket (10) is arranged at the display part (3).

7. The hands-free device as claimed in claim 1, wherein the cable (4) brought out of the housing (1) is provided with a connector (5) for contacting a cigarette lighter.

8. The hands-free device as claimed in claim 1, wherein the cable (4′) brought out of the housing (1) is connected to a permanently installed connection box (18) to which a supply voltage (+, −) and any loudspeaker (26) and microphone (7) installed can be connected.

9. The hands-free device as claimed in claim 2, wherein the cable (4, 4′) is connected to the plug-in foot (2).

10. The hands-free device as claimed in claim 1, wherein an antenna receiving traffic radio messages and an evaluation circuit decoding the traffic radio messages are arranged in the housing (1).

11. The hands-free device as claimed in claim 2, wherein the antenna is arranged in the plug-in foot (2) of the housing (1).

12. The hands-free device as claimed in claim 2, wherein the operating unit (15) is arranged at a top of the display part (3).

13. The hands-free device as claimed in claim 1, wherein the operating unit is constructed as a wireless remote control (32).
